(19) United States
(12) Patent Application Publication
(10) Pub. No.: US 2023/0315488 A1
(43) Pub. Date: Oct. 5, 2023

(54) OPTIMIZATION DEVICE, OPTIMIZATION METHOD, AND COMPUTER-READABLE RECORDING MEDIUM STORING OPTIMIZATION PROGRAM

(71) Applicant: Fujitsu Limited, Kawasaki-shi (JP)

(72) Inventor: Aki DOTE, Kawasaki (JP)

(73) Assignee: Fujitsu Limited, Kawasaki-shi (JP)

(21) Appl. No.: 18/063,704

(22) Filed: Dec. 9, 2022

(30) Foreign Application Priority Data
Apr. 4, 2022 (JP) 2022-062660

(51) Int. Cl. G06F 9/445

(52) U.S. Cl. CPC G06F 9/44505

(57) ABSTRACT

An optimization device including: a memory; and a processor coupled to the memory, the processor being configured to perform processing, the processing including: holding each of values of a plurality of state variables included in an evaluation function; performing calculation processing including calculating change values of the evaluation function when any one of the values of the plurality of state variables changes with a probability based on a weight value of each of the plurality of state variables, and calculating evaluation values that evaluate which state transition to accept among the plurality of state variables, based on the calculated change values and correction values that correspond to susceptibility to change in the state variables of which the values have been changed; and changing one of the held values of any one of the state variables among the plurality of state variables, based on the calculated evaluation values.

### CROSS-REFERENCE TO RELATED APPLICATION

This application is based upon and claims the benefit of priority of the prior Japanese Patent Application No. 2022-62660, filed on Apr. 4, 2022, the entire contents of which are incorporated herein by reference.

### FIELD

The embodiments discussed herein are related to an optimization device, an optimization method, and a non-transitory computer-readable storage medium storing an optimization program.

### BACKGROUND

As an approach for solving a combinatorial optimization problem, there is an approach of transforming the combinatorial optimization problem into an Ising model representing a spin behavior of a magnetic material and transitioning the state of the Ising model to a state with lower energy using the Markov chain Monte Carlo method. Hereinafter, the Markov chain Monte Carlo method will be abbreviated as MCMC method. The state of the Ising model can be expressed by a combination of values of a plurality of state variables and, when the number of state variables is N, can be represented, for example, as x=(x₁, x₂, . . . , x_{N}). As each state variable, a binary variable that takes a value of 0 or 1, or a spin variable that takes a value of ±1 can be used.

An Ising-type energy function E(x) representing the energy of the Ising model is defined, for example, by following formula (1).

$$\begin{matrix}[ Mathematical Formula 1 ] & \\ E ( x ) = - {\sum }_{〈 i , j 〉} {W}_{ij} {x}_{i} {x}_{j} - {\sum }_{i} {b}_{i} {x}_{i} & ( 1 )\end{matrix}$$

The first term on the right side is for integrating the products of values (0 or 1) of two state variables and a weight value (representing the strength of correlation between the two state variables) for all combinations of all state variables of the Ising model with neither omission nor duplication. The reference sign xᵢ denotes a state variable having identification information (hereinafter referred to as an index value) of i, the reference sign xⱼ denotes a state variable with an index value=j, and the reference sign Wo denotes a weight value indicating the magnitude of correlation between the state variables with index values=i and j. In addition, the range of the index values i is 1, 2, . . . , N when the number of state variables is N.

The second term on the right side is for finding the total sum of the products of bias coefficients and the state variables for each index value. The reference sign bᵢ indicates the bias coefficient for the index value=i.

In addition, when the state variable xᵢ changes to become x′ᵢ, the spin flip (a change in value of the state variable), which is the energy change ΔEᵢ associated with 1-bit flip, is represented by following formula (2). Note that formula (2) is established at the time of 1-bit flip, and the inside of the parentheses indicates the local field (total input) of the bit i. Furthermore, δxᵢ=x′ᵢ−xᵢ holds for δxᵢ.

$$\begin{matrix}[ Mathematical Formula 2 ] & \\ {Δ {E}_{i} = E ( x ) \vert}_{{x}_{i} \to {x}_{i}^{′}} - E ( x ) = - δ {x}_{i} ( {\sum }_{j} {W}_{ij} {x}_{i} + {b}_{i} ) & ( 2 )\end{matrix}$$

For the acceptance probability of a certain state transition with respect to an energy change ΔE associated with the certain state transition, an acceptance probability Aᵢ specified by the Metropolis criterion (Metropolis method) represented by following formula (3), or the like can be used.

[Mathematical Formula 3]

Aᵢ=[1,exp(−β·ΔEᵢ)] (3)

In formula (3), β denotes the inverse temperature (the reciprocal of the temperature value representing the temperature). State transitions with increasing energy are also stochastically permitted. In the usual MCMC method, a state index i to flip is selected randomly or in order of index values (sequentially), and based on the energy change ΔE associated with the state transition in which the value of the selected state variable changes, this state transition is permitted with the above-described acceptance probability Aᵢ. For example, in the MCMC method, the acceptance probability Aᵢ is compared with a uniform random number u∈(0, 1), and the flip (state transition) is permitted when u<Aᵢ is satisfied, while current state is maintained (rejection) when u<Aᵢ is not satisfied. Then, when that state transition is permitted, the value of the state variable is updated. Such processing is repeated a predetermined number of iterations.

When a state that gives the lowest energy (optimal solution) is searched for, for example, if sufficiently large β is taken (low temperature), a low energy state is achieved with a high probability. In an actual optimization problem, trapping in the local solution will happen if β is large, and thus, in a search for the optimal solution, annealing (SA: simulated annealing) that lowers the temperature slowly, or the exchange Monte Carlo method (PT: parallel tempering) that exchanges states between multiple MCMC simulations running at different temperatures such that trapping in the local solution will not happen.

In such a search for the optimal solution, since a state change will not be caused (will be rejected) at the time of the local optimal (“ΔEᵢ>0, ∀i=1, . . . , N) or a low temperature (β>>1), the solution search efficiency deteriorates, and the search takes a long time in some cases. A rejection-free scheme (hereinafter referred to as an RF method) is known as an approach for efficiently searching for the optimal solution.

In the RF method, instead of randomly choosing one flip bit and deciding whether to accept it or not, the flip bit is selected based on a weighted probability (Pᵢ) as in following formulas (4) to (7).

$$\begin{matrix}[ Mathematical Formula 4 ] & \\ {P}_{i} = {A}_{i} / {\sum }_{j = 1}^{N} {A}_{j} & ( 4 )\end{matrix}$$

$$\begin{matrix}[ Mathematical Formula 5 ] & \\ r = u {\sum }_{j}^{N} {A}_{i} & ( 5 )\end{matrix}$$

$$\begin{matrix}[ Mathematical Formula 6 ] & \\ {\sum }_{j = 1}^{k - 1} {A}_{i} < r < {\sum }_{j}^{k} {A}_{j} & ( 6 )\end{matrix}$$

$$\begin{matrix}[ Mathematical Formula 7 ] & \\ \begin{matrix}{f}_{i} = {u}_{i}^{1 / {P}_{i}} ∝ {u}_{i}^{1 / {A}_{i}} & ( Maximum value ) \\ {f}_{i} = ( log {u}_{i} ) / {A}_{i} & ( Maximum value ) \\ {f}_{i} = β max ( 0 , Δ {E}_{i} ) + log ( - log {u}_{i} ) & ( minimum value for metropolis )\end{matrix} \} & ( 7 )\end{matrix}$$

Formula (4) is a formula for the weighted probability (Pᵢ) in the RF method. In the RF method, a random number (r) is computed according to formula (5), and a bit k that satisfies formula (6) is flipped. Alternatively, an evaluation value fᵢ (stochastic key) is computed in parallel for all bits by one of the methods in formula (7), and the bit that has the maximum value or minimum value is flipped.

In this RF method, a state transition occurs in each iteration, and the state search can be made efficiently. In addition, in the RF method, the amount of computation is more than N times greater than the amount of computation in the usual MCMC, but by implementing the RF method in a parallel circuit (formula (7)), the search can be efficiently made without slowing down.

Examples of the related art include: Japanese Laid-open Patent Publication No. 2010-250599; and International Publication Pamphlet No. WO 2020/54062 are disclosed as related art.

### SUMMARY

According to an aspect of the embodiments, there is provided an optimization device including: a memory; and a processor coupled to the memory, the processor being configured to perform processing, the processing including: holding each of values of a plurality of state variables included in an evaluation function; performing calculation processing including calculating change values of the evaluation function when any one of the values of the plurality of state variables changes with a probability based on a weight value of each of the plurality of state variables, and calculating evaluation values that evaluate which state transition to accept among the plurality of state variables, based on the calculated change values and correction values that correspond to susceptibility to change in the state variables of which the values have been changed; and changing one of the held values of any one of the state variables among the plurality of state variables, based on the calculated evaluation values.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a configuration example of an optimization device according to an embodiment;

FIG. 2A is a block diagram illustrating an example of a computation unit of the optimization device according to the embodiment;

FIG. 2B is a block diagram illustrating an example of the computation unit of the optimization device according to the embodiment;

FIG. 3 is a block diagram illustrating an example of a selector of the optimization device according to the embodiment;

FIG. 4A is a flowchart illustrating an action example of the optimization device according to the embodiment;

FIG. 4B is a flowchart illustrating an action example of the optimization device according to the embodiment;

FIG. 5A is an explanatory diagram explaining an example of a flip rate;

FIG. 5B is an explanatory diagram explaining an example of the flip rate;

FIG. 5C is an explanatory diagram explaining an example of the flip rate;

FIG. 6 is an explanatory diagram explaining the relationship between the number of iterations and the probability of obtaining the lowest energy state;

FIG. 7 is a block diagram illustrating a modification of the optimization device according to the embodiment; and

FIG. 8 is an explanatory diagram explaining an example of a computer configuration.

### DESCRIPTION OF EMBODIMENTS

However, in the above-described prior art, depending on the given problem, a phenomenon will be sometimes observed in which only some (a particular plurality of) bits are flipped and the remaining bits are hardly flipped. Such a phenomenon means that the search for the optimal solution is biased toward a partial subspace of the state space and will be a cause of a significant degradation in search efficiency.

In one aspect, it is intended to provide an optimization device, an optimization method, and an optimization program that enable an efficient search for an optimal solution.

Hereinafter, an optimization device, an optimization method, and an optimization program according to embodiments will be described with reference to the drawings. Configurations having the same functions in the embodiments are denoted by the same reference signs, and redundant description will be omitted. Note that the optimization device, the optimization method, and the optimization program to be described in the embodiments below are merely examples and do not limit the embodiments. In addition, each embodiment below may be appropriately combined unless otherwise contradicted.

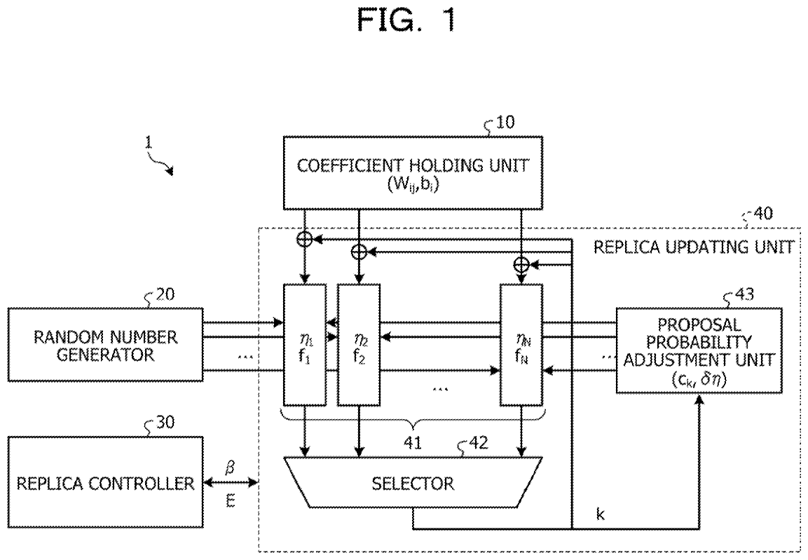

FIG. 1 is a block diagram illustrating a configuration example of an optimization device according to an embodiment. As illustrated in FIG. 1, an optimization device 1 includes a coefficient holding unit 10, a random number generator 20, a replica controller 30, and a replica updating unit 40. This optimization device 1 is an example of an optimization device that, when searching for a solution using reproduction (replicas) of a certain state (spin bit sequence with different temperature parameters) in simulated annealing using an Ising model, searches for a state at a certain temperature parameter (β). For example, for the optimization device 1, dedicated hardware with an integrated circuit, a field-programmable gate array (FPGA), or the like may be applied, or a personal computer (PC) or the like including a graphics processing unit (GPU) or a central processing unit (CPU) may be applied.

Note that, in the simulated annealing using the Ising model, only one state variable among N state variables changes in association with one state transition. Thus, in the following description, index values (i) that identify between individual state transitions from each other are assumed to be equal to the index value of one state variable. However, the index values are not limited to the mode in which the index value of the state transition and the index value of the state transition that changes in association with the state transition match.

First, an outline of the optimization device 1 will be described. In a replica, the optimization device 1 computes an evaluation value fᵢ (stochastic key) in parallel for all bits by the RF method and searches for a solution by changing (flipping) the state variable (bit k) of which the evaluation value fᵢ takes the maximum value or the minimum value. Here, in the optimization device 1, for each state variable, the evaluation value fᵢ as to whether or not to change the state variable is adjusted by a correction value (ηᵢ) corresponding to the susceptibility to change in the state variable. This allows the optimization device 1 to suppress variations in the frequency at which the state variable is changed and to restrain the search for the optimal solution from biasing toward a partial subspace of the state space.

For example, when it is assumed that one state variable to be transitioned is randomly chosen with a proposal probability qᵢ,0<qᵢ≤1 and Σᵢqᵢ=1 a transition probability (Pᵢ) of each state variable in the Metropolis method is given as Pᵢ=QᵢAᵢ=qᵢmin(1, exp(−βΔEᵢ)).

The optimization device 1 selects a flip bit (the state variable to be changed) based on a weighted probability (P′ᵢ) indicated by following formula (8). For example, a random number (r) indicated by formula (9) is computed, and the bit k that satisfies formula (10) is flipped.

$$\begin{matrix}[ Mathematical Formula 8 ] & \\ {P}_{i}^{′} = {Q}_{i} {A}_{i} / {\sum }_{j = 1}^{N} {Q}_{j} {A}_{j} & ( 8 )\end{matrix}$$

$$\begin{matrix}[ Mathematical Formula 9 ] & \\ r = u {\sum }_{j}^{N} {Q}_{j} {A}_{i} & ( 9 )\end{matrix}$$

$$\begin{matrix}[ Mathematical Formula 10 ] & \\ {\sum }_{j = 1}^{k - 1} {Q}_{j} {P}_{j} < r < {\sum }_{j}^{k} {Q}_{j} {A}_{j} & ( 10 )\end{matrix}$$

For example, in the optimization device 1, the replica updating unit 40 computes the evaluation value (fᵢ) for evaluating whether or not to accept the state transition, in parallel for all (N) bits by following formula (11), and flips the bit that has the minimum value.

[Mathematical Formula 11]

fᵢ=β(max(0,ΔEᵢ)+ηᵢ)+log(−log uᵢ)(Minimum Value for metropolis) (11)

In this formula (11), ηᵢ included in the former term part denotes the correction value corresponding to the susceptibility to change in the state variable. In addition, the latter term part is an example of the random number. In formula (11), the sum of the acceptance probability of the state transition and the random number is calculated as the evaluation value.

Here, regarding the greater the value, the lower the probability that the state variable will be flipped (changed). Therefore, for bits (state variables) that are susceptible to change, a great value only has to be set in advance as the correction value (ηᵢ) in a memory or the like. In principle, the relationship ηᵢ=−log(qᵢ)≥0 is satisfied with the proposal probability qᵢ. However, in the algorithm that searches for the minimum value using formula (11), all the state variables will be unchanged even if taking ηᵢ→ηᵢ+a with an appropriate real number a, and thus any value may be used for the correction value (ηᵢ).

In addition, in the optimization device 1, the replica updating unit 40 may dynamically adjust the correction value (ηᵢ) for each state variable while searching for a solution. For example, the replica updating unit 40 determines the correction value (ηᵢ) based on the number of times each state variable (bit i) identified by the index value (i) has been changed by the evaluation value (fᵢ).

For example, the replica updating unit 40 finds the bit flip rate based on the number of times the bit i has been changed. The flip rate is assumed as the number of times the bit i has been flipped/the number of iterations in the solution search. The replica updating unit 40 measures the above flip rate during a fixed number of iterations and increases the correction value (ηᵢ) until the flip rate falls within a threshold value (for example, 3×1/N).

As an example, the replica updating unit 40 performs the processes of 1. measuring the flip rate, 2. increasing ηᵢ of one bit with the greatest flip rate or a bit exceeding a threshold value (ηᵢ=ηᵢ+δη), and 3. repeating 1 and 2 above until the maximum value of the flip rate becomes equal to or less than the threshold value. In the above processes, if δη>0 is sufficiently small, the flip rate of each bit converges to the threshold value or less.

Note that, the replica updating unit 40 may group the state variables in advance on the basis of the values of the coefficients of the problem, or the like, and for each of these groups, determine the correction value within the group, based on the number of times the change by the evaluation value (f) has been made. For example, ΣⱼWᵢⱼ+bᵢ in formula (2) is computed for each variable (i), and bits with similar values are grouped. By assuming the flip rate as (the number of flips in each group)/(the number of iterations×the number of bits in each group), the replica updating unit 40 finds an average flip rate within the group. Next, the replica updating unit 40 finds the correction value (q) of each bit within the group by performing processes similar to the above-described processes on the basis of the average flip rate within the group. Note that, when a plurality of independent simulations (replicas) is executed (details will be described later), the flip rate may be found by averaging the same bits or groups of separate replicas, and the correction value (q) may be found.

In addition, the replica updating unit 40 may find an average value of the energy change values (ΔEᵢ) in formula (2), for each state variable (bit i) identified by the index value (i), and determine the correction value (ηᵢ) based on the obtained average value.

For example, the replica updating unit 40 finds, for example, an average value of

[Mathematical Formula 12]

max(0,ΔEᵢ(x^{(t)}))

(x^{(t)}=(x₁^{(t)},x₂^{(t)}, . . . ,x_{N}^{(t)}) Denotes state at number of iterations t)

that changes every time an iteration is performed, for each bit. From this average value, the correction value (ηᵢ) is given as in following formula (12).

$$\begin{matrix}[ Mathematical Formula 13 ] & \\ {η}_{i} = - \frac{1}{L} {\sum }_{\{ t = 1 \}}^{L} max ( 0 , Δ {E}_{i} ( {x}^{( t )} ) ) & ( 12 )\end{matrix}$$

Subsequently, the configuration of the optimization device 1 will be described. For example, the coefficient holding unit 10 is a register, a static random access memory (SRAM), or the like. The coefficient holding unit 10 holds each of the values of a plurality of state variables included in an evaluation function representing energy and additionally, outputs the values of the plurality of state variables at every predetermined number of iterations. The evaluation function is, for example, the energy function E(x) as indicated by formula (1).

The random number generator 20 generates random numbers used by the replica updating unit 40. The random number generator 20 produces a random number value r=log(−log(uᵢ))), where uᵢ's are the independent uniform random numbers greater than zero but equal to or less than one, for example. The random number generator 20 can be achieved, for example, using a Mersenne Twister, linear feedback shift register (LFSR), or the like.

The replica controller 30 sets values (the energy E and the inverse temperature (or temperature) β) relating to reproduction (replicas) of a certain state (spin bit sequence with different temperature parameters).

The replica updating unit 40 is a processing unit that searches for a state (solution space) using the replicas set by the replica controller 30. For example, the replica updating unit 40 includes a computation unit 41, a selector 42, and a proposal probability adjustment unit 43.

The computation unit 41 is a processing unit that computes the evaluation value fᵢ in parallel for all bits from 1 to N, by the RF method, while adjusting with the correction value (ηᵢ) corresponding to the susceptibility to change in the state variable.

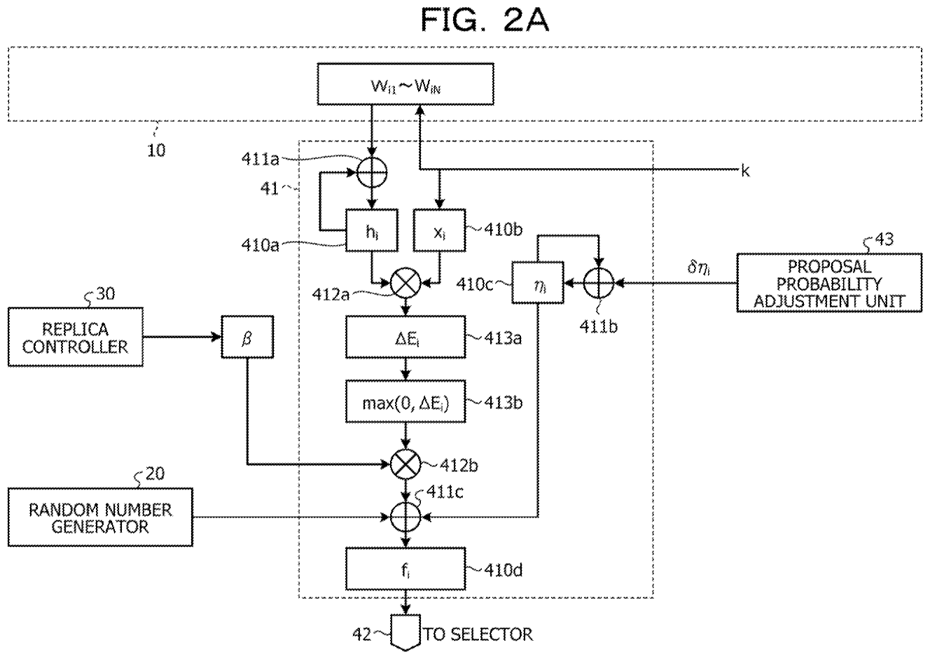

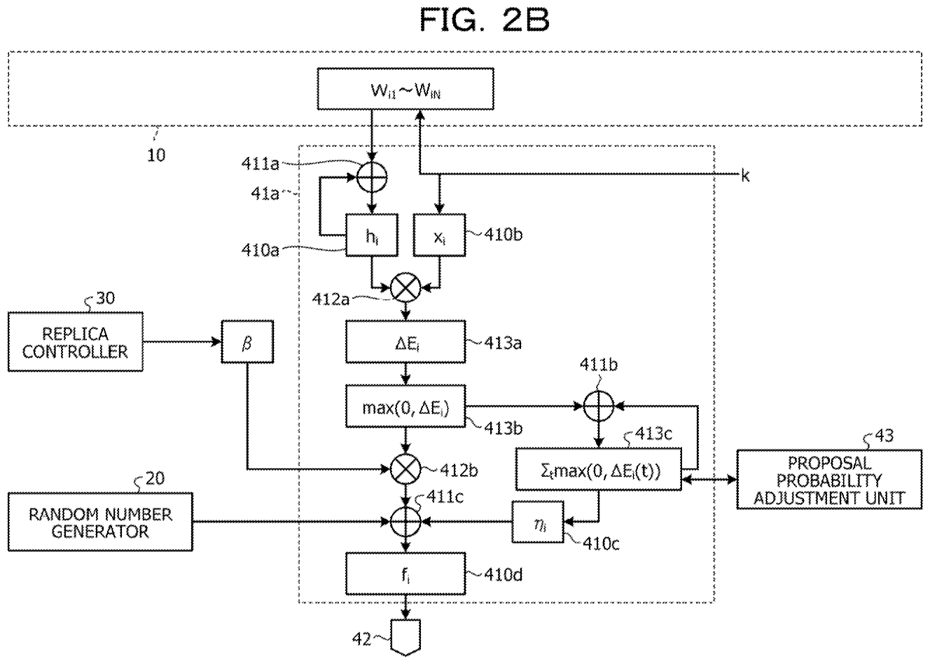

FIGS. 2A and 2B are block diagrams illustrating examples of the computation unit of the optimization device according to the embodiment. For example, as illustrated in FIG. 2A, the computation unit 41 for each state variable (bit i) includes registers 410a to 410d, adders 411a to 411c, integrators 412a and 412b, and arithmetic units 413a and 413b. Note that k indicates the index of the bit selected to be flipped by the selector 42.

The registers 410a to 410d hold values (the local field hᵢ and the state xᵢ) read from the coefficient holding unit 10, the correction value (ηᵢ), the evaluation value (fᵢ), and the like for the state variable (bit i).

For example, for the state variable (bit i), the values (hᵢ and xᵢ) read from the coefficient holding unit 10 are held in the registers 410a and 410b. The adder 411a updates hᵢ by adding the value read from the coefficient holding unit 10 to hᵢ held in the register 410a.

The integrator 412a integrates hᵢ held in the register 410a and xᵢ held in the register 410b. The arithmetic unit 413a calculates ΔEᵢ by performing arithmetic on formula (2) on the basis of the arithmetic result of the integrator 412a.

The arithmetic unit 413b calculates max(0, ΔEᵢ) on the basis of ΔEᵢ calculated by the arithmetic unit 413a. The integrator 412b integrates max(0, ΔEᵢ) calculated by the arithmetic unit 413b by β (inverse temperature).

The adder 411c adds the correction value (nu) held in the register 410c to β(max(0, ΔEᵢ)). This obtains a value corresponding to the first term of formula (11).

In addition, the adder 411c adds the random number (corresponding to the second term of formula (11)) generated by the random number generator 20 to the value corresponding to the first term of formula (11). The computation unit 41 obtains fᵢ by an arithmetic process up to this adder 411c. Obtained fᵢ in this manner is stored in the register 410d.

The adder 411b adds δηᵢ notified by the proposal probability adjustment unit 43 to ηᵢ stored in the register 410c to update ηᵢ.

FIG. 2B depicts the computation unit 41a when the average value of the energy change values (ΔEᵢ) in (2) is found and the correction value (ηᵢ) is determined based on the obtained average value. As illustrated in FIG. 2B, the computation unit 41a differs from the computation unit 41a in FIG. 2A in including an arithmetic unit 413c that performs arithmetic on formula (12).

The selector 42 selects the state variable (bit k) of which the evaluation value fᵢ computed by the computation unit 41 takes the maximum value or the minimum value and changes (flips) the selected state variable.

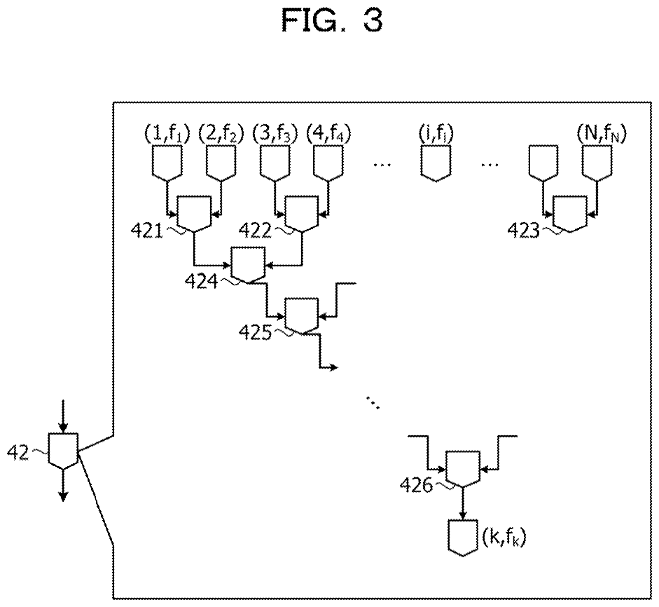

FIG. 3 is a block diagram illustrating an example of the selector 42 of the optimization device 1 according to the embodiment. As illustrated in FIG. 3, the selector 42 includes a plurality of selection circuits (such as selection circuits 421 to 426) arranged in a plurality of stages in a tree form. For two evaluation values, each selection circuit in the first stage selects and outputs the greater evaluation value (in the case of the maximum value) and the index value corresponding to the greater evaluation value. For example, when an evaluation value f₁ with an index value of 1 (i=1) is greater than an evaluation value f₂ with an index value of 2 (i=2), the selection circuit 421 outputs the evaluation value f₁ and its index value of 2. Note that, when the minimum value is selected, for two evaluation values, each selection circuit selects and outputs the smaller evaluation value and the index value corresponding to the smaller evaluation value.

As in the first stage, the selection circuits in the second and subsequent stages select and output the greater evaluation value and the index value corresponding to the greater evaluation value for two evaluation values output by two selection circuits in the previous stage.

In this manner, the selector 42 selects one state variable (bit k) of which the evaluation value fᵢ takes the maximum value or the minimum value, by selecting one of the state variables based on the magnitude relationship between the evaluation values of the respective state variables. The selector 42 outputs the selected state variable to the coefficient holding unit 10 and changes the value of the selected state variable.

The proposal probability adjustment unit 43 sets the correction value (ηᵢ) for each state variable in the computation unit 41. For example, the proposal probability adjustment unit 43 may read ηᵢ preset in a memory or the like and set read ηᵢ in the computation unit 41 for each state variable.

In addition, the proposal probability adjustment unit 43 acquires the changed (flipped) state variable (bit k) from the selector 42 and counts the acquired state variable (bit k) as the number of flips (cₖ). In this manner, the correction value (ηᵢ) for each state variable may be set on the basis of the number of flips counted for each state variable. For example, the proposal probability adjustment unit 43 is an example of a determination unit.

For example, as described above, the proposal probability adjustment unit 43 finds the flip rate on the basis of the number of flips and the number of iterations for solution. Next, the proposal probability adjustment unit 43 increases (δη) the correction value of each state variable, based on the comparison result between the obtained flip rate and a threshold value.

Note that, as described above, the proposal probability adjustment unit 43 may count the number of flips of the state variable for each group preset on the basis of the values of the coefficients of the problem, or the like, and find the average flip rate for each group. In this case, the proposal probability adjustment unit 43 increases (δη) the correction value of the state variable within each group, based on the comparison result between the average flip rate within the group and the threshold value.

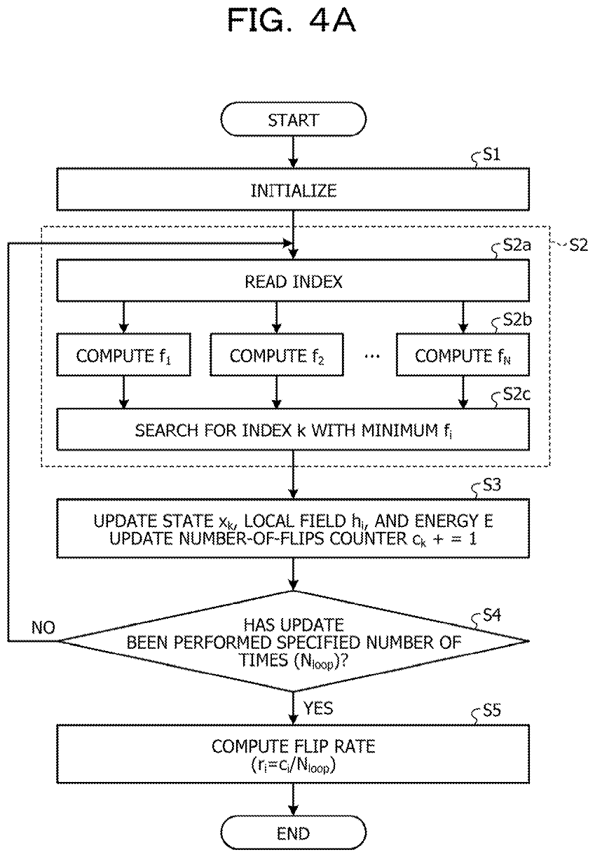

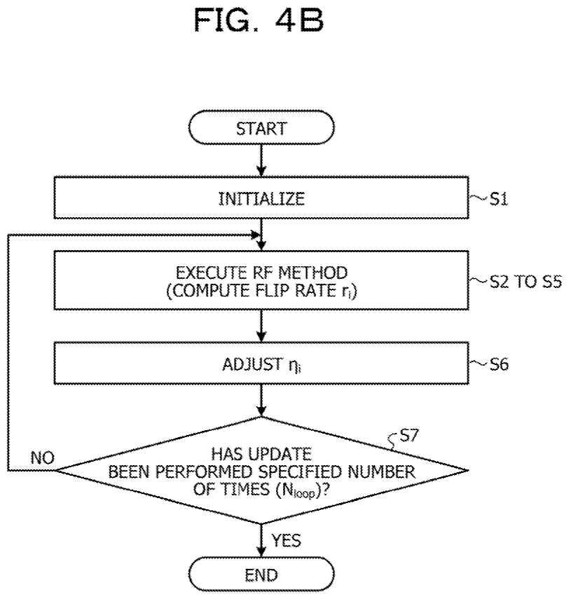

FIG. 4A is a flowchart illustrating an action example of the optimization device 1 according to the embodiment. As illustrated in FIG. 4A, when the process is started, the optimization device 1 performs an initialization process (S1).

For example, in the initialization process, the replica controller 30 sets parameters such as the number of repetitions (specified number of times Nₗₒₒₚ) for finding the solution and the inverse temperature (β) in the replica updating unit 40. In addition, the proposal probability adjustment unit 43 reads preset in a memory or the like to set read in the computation unit 41 and resets the number of flips (cₖ).

Next, the computation unit 41 performs a process of computing the evaluation value (fᵢ) for evaluating whether or not to accept the state transition, in parallel for all (N) bits by formula (11), and searching for the bit (index k) that has the minimum value (S2).

For example, the computation unit 41 reads values (the local field hᵢ and the state xᵢ) corresponding to the index, from the coefficient holding unit 10 (S2a), and computes the evaluation values f₁ to f_{N} in parallel for all (N) bits (S2b). Next, the selector 42 compares the evaluation values f₁ to f_{N} computed by the computation unit 41 and searches for the index k that has the minimum value (S2c).

Next, the selector 42 updates the values stored in the coefficient holding unit 10, such as the state xₖ, the local field hᵢ, and the energy E, corresponding to the index k that has the minimum value. In addition, the proposal probability adjustment unit 43 increments and updates the number-of-flips counter (cₖ) corresponding to the index k (S3).

Next, the replica controller 30 verifies whether or not the state variable has been updated the specified number of times Nₗₒₒₚ (S4) and, when the verification is negative (S4: No), returns the process to S2. This will cause the optimization device 1 to search for a solution until the specified number of times Nₗₒₒₚ is reached.

When the verification in S4 is affirmative (S4: Yes), the proposal probability adjustment unit 43 computes the flip rate (rᵢ) on the basis of the number of flips (cᵢ) for each state variable (S5) and ends the process. For example, this computation of the flip rate (rᵢ) is given as rᵢ=cᵢ/Nₗₒₒₚ or the like. Note that, when the state variables are grouped, the proposal probability adjustment unit 43 may count the number of flips of the state variable for each group and find the average flip rate for each group.

FIG. 4B is a flowchart illustrating an action example of the optimization device 1 according to the embodiment and, for example, is an action example of a case where the correction value (ηᵢ) for each state variable is dynamically adjusted while a solution is searched for.

As illustrated in FIG. 4B, when the process is started, the optimization device 1 performs the above-described initialization process (S1). Next, the optimization device 1 executes the processes from S2 to S5 described above and executes the RF method including the computation of the flip rate (rᵢ).

Next, the proposal probability adjustment unit 43 sets (adjusts) the correction value (ηᵢ) for each state variable as described above on the basis of the flip rate (rᵢ) of each state variable (S6).

For example, the proposal probability adjustment unit 43 sets the correction value (ηᵢ) for each state variable as follows, as a method for suppressing the maximum value of the flip rate. ⋅ Take ηₖ→ηₖ+δη for the bit k in which rᵢ has the maximum value. ⋅ Take a predetermined value designated beforehand for δη. ⋅ Application not only to the maximum value but also to the bits equal to or greater than the threshold value is acceptable.

In addition, the proposal probability adjustment unit 43 sets the correction value (ηᵢ) for each state variable as follows, as a method for giving a slope to the flip rate. For each state variable, take ηᵢ→ηᵢ+δη·rᵢ, for example. ⋅ Instead of multiplying by δη, rᵢ may be transformed with an appropriate monotonically increasing function.

In addition, the proposal probability adjustment unit 43 may perform the following when setting the correction value (ηᵢ) by grouping the state variables. ⋅ The average is taken within the group as the flip rate, and the same value of ηᵢ is used within the group. When a plurality of replicas is used, the flip rates of the same index may be summed up and averaged between the replicas.

Note that, when all the correction values (ηᵢ) meet ηᵢ>0, the proposal probability adjustment unit 43 may subtract the minimum correction value from the whole. This allows the proposal probability adjustment unit 43 to restrain ηᵢ from increasing infinitely.

Next, the replica controller 30 verifies whether or not the state variable has been updated the specified number of times Now (S7) and, when the verification is negative (S7: No), returns the process to S2. When the verification is affirmative (S7: Yes), the replica controller 30 ends the process.

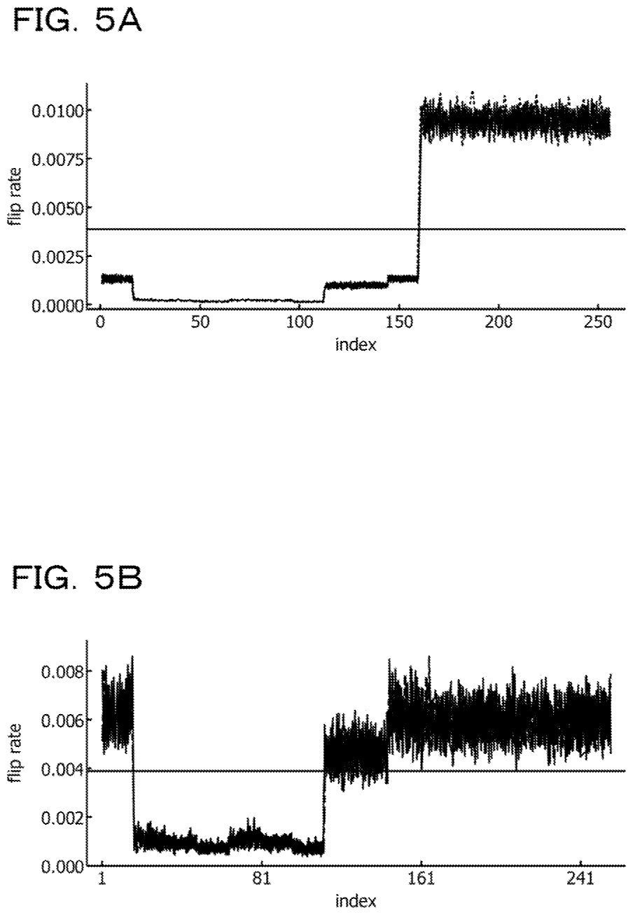

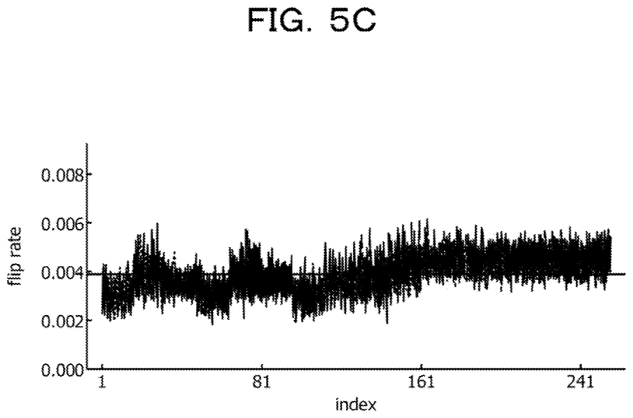

FIGS. 5A to 5C are explanatory diagrams explaining examples of the flip rate. For example, in FIGS. 5A to 5C, the horizontal axis indicates the index values of 256 state variables (index), and the vertical axis indicates the flip rate for each index value (flip rate). Here, the parallel lines in the figure represent the flip rate 1/N when all bits are equivalent. In addition, FIG. 5A depicts a case of no correction using no correction value (η). FIG. 5B depicts a case where the group of state variables with index values equal to and greater than 161 is corrected using a common correction value (η=5). FIG. 5C depicts a case where also the index values less than 161 are further divided into four groups and corrected using the correction value (η) of each group.

As illustrated in FIG. 5A, with no correction, the flip rate in the latter half (index ≥161) is 5 to 10 times higher than in the former half. For example, the search for the optimal solution will be biased toward a partial subspace of the state space.

In FIG. 5B, the flip rate in the latter half (index ≥161) is close to the flip rate in the former half part, compared with the case in FIG. 5A. In addition, in FIG. 5C, the bias in the flip rate is further improved, and the bias in the flip rate becomes smaller over all indices.

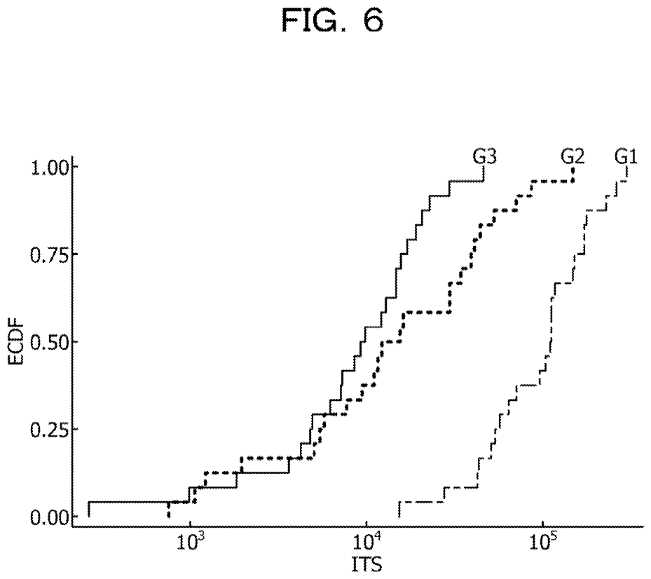

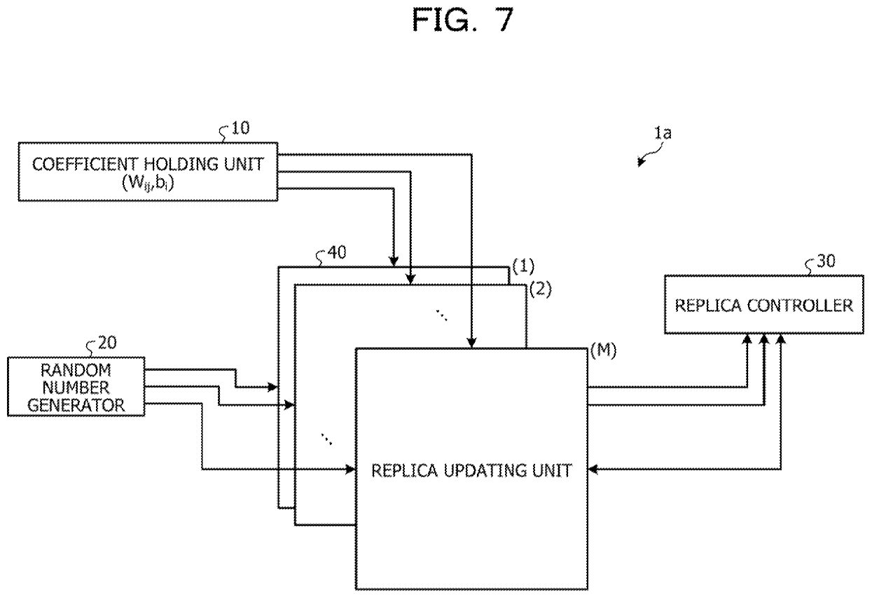

FIG. 6 is an explanatory diagram explaining the relationship between the number of iterations and the probability of obtaining the lowest energy state. In FIG. 6, the horizontal axis represents the number of iterations until a solution is obtained (ITS: iteration number to solution), and the vertical axis represents the empirical cumulative distribution function (ECDF) in which the solution was obtained when the experiment was repeated a plurality of times.

In addition, a graph G1 is a graph indicating the arithmetic result under the same condition (no correction) as in FIG. 5A. A graph G2 is a graph indicating the arithmetic result under the same condition as in FIG. 5B (the group of state variables with index values equal to and greater than 161 is corrected using the same correction value (η=5)). A graph G3 is a graph indicating the arithmetic result under the same condition as in FIG. 5C (also the index values less than 161 are further divided into four groups and corrected using the correction value (η) of each group).

As illustrated in FIG. 6, it can be seen that the graphs G2 and G3 with correction can obtain a solution faster (in a shorter number of iterations) than the graph G1 with no correction. For example, when the graphs G1, G2, and G3 are compared at a portion with an ECDF of 0.50 (which is a success rate of 50%), the average number of iterations to find a solution can be reduced to 1/10.

FIG. 7 is a block diagram illustrating a modification of the optimization device according to the embodiment. For example, FIG. 7 illustrates a configuration example of an optimization device 1a that uses parallel tempering (PT, also called the exchange Monte Carlo method).

As illustrated in FIG. 7, the optimization device 1a that uses PT simultaneously performs the MCMC method using a plurality (1 to M) of replica updating units 40. The replica controller 30 compares the energy of the state of each of the replica updating units 40 at every certain number of iterations and performs an operation of exchanging the states for two temperatures (or the temperatures) with a proper probability.

In this manner, in the optimization device 1a that uses PT, by applying the replica updating units 40 described above, all bits are evenly caused to flip even at a low highest temperature, and an efficient search is enabled by decreasing the number of replicas. In addition, the replica controller 30 lowers the temperature (increases β) in accordance with a schedule designated in advance, at every certain number of iterations. In this case, the plurality of replica updating units 40 performs searches independently and simply serves to raise the success rate of locating a solution.

As described above, the optimization device 1 holds each of the values of a plurality of state variables included in the evaluation function representing the energy. In addition, the optimization device 1 computes the energy change value (ΔE) when any one of the values of the plurality of state variables changes with a probability based on the weight value of each state variable. Then, based on the computed change value and the correction value (η) corresponding to the susceptibility to change in the changed state variable, the optimization device 1 calculates the evaluation value (f) for evaluating whether or not to accept the state transition. The optimization device 1 changes any one of the held values of the plurality of state variables, based on the calculated evaluation value (f).

This allows the optimization device 1 to restrain the search for the optimal solution from biasing toward a partial subspace of the state space as only some state variables are changed and the remaining state variables are hardly changed. In this manner, the optimization device 1 may achieve an efficient solution search in which the search for the optimal solution is not biased toward a partial subspace of the state space.

In addition, the optimization device 1 determines the correction value for each state variable, based on the number of times the change by the evaluation value (f) has been made. This allows the optimization device 1 to use the correction value corresponding to an actual change in the state variable during the search for the optimal solution.

In addition, for each group of the state variables, the optimization device 1 determines the correction value within the group, based on the number of times the change by the evaluation value (f) has been made. For example, regarding the state variables, state variables with similar susceptibility to change can be grouped together on the basis of the values of the coefficients of the problem (Ising model), or the like. Therefore, in the optimization device 1, by determining the correction value for each group, the correction value may be determined more efficiently than when the correction value is determined for each state variable.

In addition, the optimization device 1 determines the correction value based on the average of the energy change values when changed by the evaluation value (f). This allows the optimization device 1 to determine the correction value of each state variable such that, for example, the average of the energy change values is approximately the same.

Note that each of the illustrated components in each of the devices does not necessarily have to be physically configured as illustrated in the drawings. For example, specific modes of distribution and integration of the respective devices are not limited to those illustrated, and all or a part of the devices may be configured by being functionally or physically distributed and integrated in an optional unit according to various loads, use situations, and the like.

In addition, not only various processing functions of the coefficient holding unit 10, the random number generator 20, the replica controller 30, and the replica updating unit 40 of the optimization device 1 are implemented on a dedicated integrated circuit or FPGA, but also all or an optional part of the various processing functions may be executed on a CPU (or a microcomputer such as a micro processing unit (MPU) or micro controller unit (MCU)). In addition, it is needless to say that all or an optional part of the various processing functions may be executed on a program analyzed and executed by a CPU (or a microcomputer such as an MPU or an MCU) or on hardware by wired logic. Furthermore, the various processing functions performed by the optimization device 1 may be executed by a plurality of computers in cooperation through cloud computing.

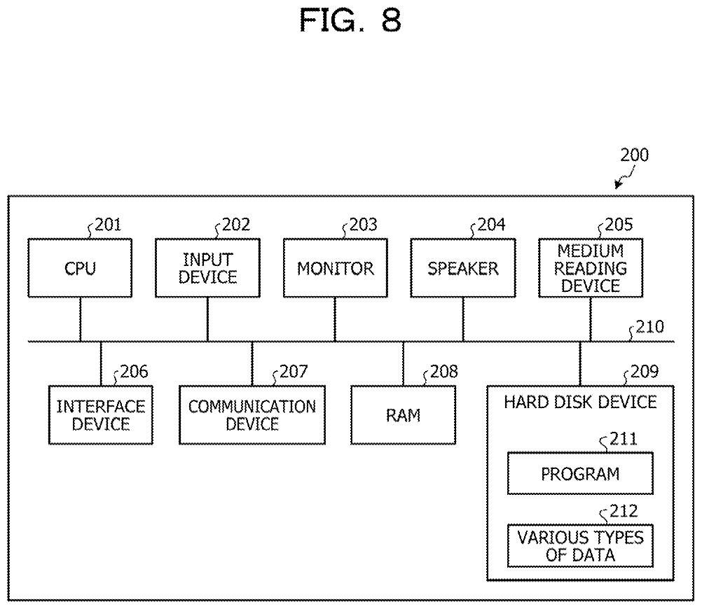

Meanwhile, various processes described in the above embodiments may be achieved by a computer executing a program prepared in advance. Thus, hereinafter, an example of a computer configuration (hardware) that executes a program having functions similar to the functions of the above embodiments will be described. FIG. 8 is an explanatory diagram explaining an example of the computer configuration.

As illustrated in FIG. 8, a computer 200 includes a CPU 201 that executes various arithmetic processes, an input device 202 that receives data input, a monitor 203, and a speaker 204. In addition, the computer 200 includes a medium reading device 205 that reads a program and the like from a storage medium, an interface device 206 for connecting to various devices, and a communication device 207 for connecting to and communicating with an external device in a wired or wireless manner. Furthermore, the optimization device 1 includes a random access memory (RAM) 208 that temporarily stores various types of information, and a hard disk device 209. Moreover, each of the units (201 to 209) in the computer 200 is connected to a bus 210.

The hard disk device 209 stores a program 211 for executing various processes in the functional configuration (for example, the coefficient holding unit 10, the random number generator 20, the replica controller 30, and the replica updating unit 40) described in the above embodiments. In addition, the hard disk device 209 stores various types of data 212 that the program 211 refers to. The input device 202 receives, for example, input of operation information from an operator. The monitor 203 displays, for example, various screens operated by the operator. The interface device 206 is connected to, for example, a printing device or the like. The communication device 207 is connected to a communication network such as a local area network (LAN) and exchanges various types of information with an external device via the communication network.

The CPU 201 reads the program 211 stored in the hard disk device 209 and loads the program 211 into the RAM 208 to execute, thereby performing various processes relating to the functional configuration (for example, the coefficient holding unit 10, the random number generator 20, the replica controller 30, and the replica updating unit 40) described above. Note that the program 211 does not have to be stored in the hard disk device 209. For example, the program 211 stored in a storage medium readable by the computer 200 may be read and executed. For example, the storage medium readable by the computer 200 corresponds to a portable recording medium such as a compact disc read only memory (CD-ROM), a digital versatile disc (DVD) disk, or a universal serial bus (USB) memory, a semiconductor memory such as a flash memory, a hard disk drive, or the like. In addition, this program 211 may be prestored in a device connected to a public line, the Internet, a LAN, or the like, and the computer 200 may read the program 211 from this device and execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optimization device comprising:
a memory; and
a processor coupled to the memory, the processor being configured to perform processing, the processing including:
holding each of values of a plurality of state variables included in an evaluation function;
performing calculation processing including calculating change values of the evaluation function when any one of the values of the plurality of state variables changes with a probability based on a weight value of each of the plurality of state variables, and calculating evaluation values that evaluate which state transition to accept among the plurality of state variables, based on the calculated change values and correction values that correspond to susceptibility to change in the state variables of which the values have been changed; and
changing one of the held values of any one of the state variables among the plurality of state variables, based on the calculated evaluation values.

2. The optimization device according to claim 1, wherein
the performing of the calculation processing includes calculating the change values of the evaluation function in parallel for the plurality of state variables, and calculating the evaluation values in parallel for the plurality of state variables.

3. The optimization device according to claim 2, the processing further comprising:
selecting a first state variable included in the plurality of state variables, based on the evaluation values, wherein
the changing of the one of the held values includes changing one of the values for the first state variable selected by the selecting of the first state variable.

4. The optimization device according to claim 1, the processing further comprising:
determining the correction values based on a number of times the changing has been made, for each of the plurality of state variables.

5. The optimization device according to claim 4, wherein
the determining of the correction values includes determining the correction values within a group of the plurality of state variables for each group, based on the number of times the changing has been made.

6. The optimization device according to claim 4, wherein
the determining of the correction values includes determining the correction values based on an average of the change values when the changing has been made.

7. An optimization method implemented by a computer, the optimization method comprising:
holding each of values of a plurality of state variables included in an evaluation function;
performing calculation processing including calculating change values of the evaluation function when any one of the values of the plurality of state variables changes with a probability based on a weight value of each of the plurality of state variables, and calculating evaluation values that evaluate which state transition to accept among the plurality of state variables, based on the calculated change values and correction values that correspond to susceptibility to change in the state variables of which the values have been changed; and
changing one of the held values of any one of the state variables among the plurality of state variables, based on the calculated evaluation values.

8. A non-transitory computer-readable storage medium storing an optimization program for causing a computer to perform processing including:
holding each of values of a plurality of state variables included in an evaluation function;
performing calculation processing including calculating change values of the evaluation function when any one of the values of the plurality of state variables changes with a probability based on a weight value of each of the plurality of state variables, and calculating evaluation values that evaluate which state transition to accept among the plurality of state variables, based on the calculated change values and correction values that correspond to susceptibility to change in the state variables of which the values have been changed; and
changing one of the held values of any one of the state variables among the plurality of state variables, based on the calculated evaluation values.
